(19) United States
(12) Patent Application Publication
(10) Pub. No.: US 2003/0231752 A1
(43) Pub. Date: Dec. 18, 2003

(54) Telephone calling way by personal number ignoring routing information

(76) Inventor: Benshan Wang, Chengdu (CN)

Correspondence Address: Edward & Angell, LLP, P. O. Box 9169, Boston, MA, 02209, US

(21) Appl. No.: 10/422,071

(22) Filed: Apr. 23, 2003

Related U.S. Application Data
(63) Continuation-in-part of application No. PCT/CN01/01498, filed on Oct. 23, 2001.

(30) Foreign Application Priority Data
Oct. 23, 2000 (CN) 00120501.3

(51) Int. Cl. H04M 3/42

(52) U.S. Cl. 379/201.02; 379/211.01

(57) ABSTRACT

A telephone calling way based upon an association system is disclosed. The association system, as a database system recording the relation between a subscriber's personal number and his/her current-in-use telephone number(s), has widely-distributed workstations and runs outside a telephone telecommunication system (TTS). It is not only able to assist a TTS to convert a personal number to its relevant telephone number locally, but also able to make a subscriber to input his/her current-in-use phone number locally even after he/she has relocated. And a subscriber's personal number, given by the database system, is designed totally without any telephone telecommunication routing information in order to make the subscriber, even after having changed his/her telephone telecommunication provider, be still reachable by his/her friends based on his/her personal number for his/her all lifetime. The telephone calling way is a cheaper way both to TTS' and a customer. And the way makes a customer feel easy since what, a caller has to do for a telephone calling process, is only to dial the called person's personal number following a signal number, as the signal of the personal calling way of the present invention, but any telephone geographic code etc.

### REFERENCE TO RELATED APPLICATIONS

This is a continuation-in-part of International Application Number PCT/CN01/01498 with an international filing date of Oct. 23, 2001, which claims benefit of priority of Chinese Application Number 00120501.3(CN) having a filing date of Oct. 23, 2000.

### REFERENCES

1) ITU-T Recommendation F.850 (1993), Principles of Universal Personal Telecommunication (UPT).

2) ITU-T Recommendation F.851 (1995), Universal Personal Telecommunication (UPT)-Service Description (Service Set 1).

3) ITU-T Recommendation F.853 (1998), Supplementary Service in the Universal Personal Telecommunication (UPT) Environment.

4) ITU-T Recommendation F.852(2000), Universal Personal Telecommunication (UPT)-(Service Set 2)

5) ITU-T Recommendation E.168 (1999), Application of E164 Numbering Plan for UPT.

6) ITU-T Recommendation D.280 (1985), Principles of Charging and billing Accounting and Reimbursements for Universal Personal Telecommunication.

7) ITU-T Recommendation E.174 (1995), Routing Principles and Guidance for Universal Personal Telecommunication (UPT)

### FIELD OF THE INVENTION

This invention relates to a telephone calling way, more particularly, to a person-oriented telephone calling way by dialing a called person's person-oriented number without any telephone telecommunication routing information.

### BACKGROUND OF THE INVENTION

“Who is the boss in a current telephone calling process?”. The question is helpful to understand the basis of the present invention.

The current telephone calling way, in view of behavior sciences, can be named as a machine-oriented telephone calling way since a calling process of the current telephone systems is based upon a telephone number, while any kind of the telephone number is number of a real machine-set and is defined by telephone telecommunication routing information. Every traditional telephone calling process belongs to the machine-oriented telephone calling way even though there have appeared wireless telephone and web telephone systems rather than wire telephone system.

But there exist, along with the machine-oriented telephone calling way, some troubles difficult to solve.

At, first, there is a great number of null calling processes in the current telephone system resulting from using the machine-oriented telephone calling way. This is because, in view of behavior sciences, that a machine-oriented telephone calling process is a call from a caller's phone set to a called phone set but not directly to the called person who may be served by the called phone set. And the call will be doomed to fail if the person is not located near the called telephone set.

Secondly, the machine-oriented telephone calling way cannot be run coordinately with human being's activities. For example, a person often needs to change his telephone set or telephone number as he moves elsewhere, when he choices a new work department or an other telephone telecommunication provider, when he changes his telephone sets at office and home, when he is in his traveling or when the machine-oriented telephone telecommunication company serving the person increases all of its telephone numbers from 7 digits to 8 digits etc. Government offices and private companies also often change their telephone numbers. More interesting, in view of psychology, there exist many problems, which are worth considering: there is a lot of persons who do not want their home phone numbers known by their customers though they hope that they can be easily reached by their customers; there exists some one, especially a wireless telephone user, who hopes his cellular phone set reachable by private affairs but not business affairs during some period every day, and there is also someone who does not hope his caller knowing where he is located.

It seems that people had to choice the machine-oriented telephone calling way in Bell's invention time since there did not exist database and Internet techniques.

As a matter of the fact, the current sciences, especially, database technique and web technique, have already prepared the technical foundation for a person-oriented telephone calling way, in addition to the machine-oriented telephone calling way.

The modern telephone calling ways to solve the above problems are Personal Communication Service (PCS) and Universal Personal Telecommunication (UPT). Both PCS and UPT are based upon TRA-Call Transfer function. The difference between PCS and UPT is that PCS may use a real machine-oriented telephone number as a dialed number while UPT uses a virtual phone number as a dialed number. Both PCS and UPT run based on database.

UPT way looks more agile than PCS way but still has some troubles with it because a UPT personal number is dependent on a UPT provider though it is, certainly, a kind of person-oriented number. But the situation shows that UPT way, like PCS way, makes a subscriber still fixed on a telecommunication provider. Therefore, in view of behavior sciences, a UPT calling process is not a real person-oriented process, which will result in some troubles to a user. For example, if a man migrated to another geographic area and had to change his UPT provider, his UPT number would have to be changed. And if a man's UPT number had been changed, he might lose his communication with some friends and customers. If a user or businessman does not want to lose his customers and does not want to change his UPT number assuming that he has moved from New York to London, he will have to send his bill to the original UPT provider in New York! Who would think this way is easy for both him and his UPT provider? But charging and billing processes are very important problems of UPT way.

### SUMMARY OF THE INVENTION

According to the way of the present invention, a telephone calling process is different from the way used in UPT though both the two ways should do converting a person-oriented number to a machine-oriented telephone number.

The new idea of the present invention is (1) to isolate a subscriber's person-oriented number with any telecommunication provider in order that a person-oriented number has not any telephone telecommunication routing information; and (2) to make a person-oriented number owned uniquely by one person in order that a subscriber's person-oriented number is like his worldwide I.D. number; (3) to run a telephone calling process based totally on a subscriber's person-oriented number in order that a person can keep his/her touch with friends and customers for all of his/her lifetime; (4) to make an association system, as an assisting system to help with TTS', to convert a person-oriented number to its relevant machine-oriented telephone number in order that the current TTS' do their calling process in a usual way. It is certainly very important that a subscriber should put his person-oriented number on his business card in advance.

In accordance with the first aspect of the present invention, the person-oriented calling way of the invention runs based on an association system, which can be connected with a telephone telecommunication system (TTS), but only based on a TTS completely.

In accordance with the second aspect of the present invention, the association system, in fact, is a database system depending on web technique. The database records the relation between a subscriber's person-oriented number and its relevant machine-oriented telephone number(s), which may serve him currently. And the database system consists of many enough workstations. And the database system, via its workstation, can be queried by a TTS.

In accordance with the third aspect of the present invention, a workstation of the database system will be connected with a TTS under the case that the TTS has accepted a special number dialed by a caller as the signal of the person-oriented calling way.

The signal number, as the signal of the person-oriented calling way, is a user number of TTS'. And the signal number, as a user number of TTS', will depend on the application of the database system to TTS'. It is, obviously, better that the signal number is unique throughout the world.

In accordance with the fourth aspect of the present invention, a person-oriented number of any subscribers is an independent number which has not any routing information for telephone telecommunication service. This can make it easy for a long time to do converting from a person-oriented number to its relevant machine-oriented telephone number of any kind (but only one kind) of current or future TTS based on the present invention.

In accordance with the fifth aspect of the present invention, a workstation is an object, queried by TTS', but not a subject, which will send voice and/or data to TTS actively. When doing updating data and passing updated data, a workstation of the database system is a user of TTS', but not an assisting part of TTS' to do tasks for TTS'.

In accordance with the sixth aspect of the present invention, every person-oriented number given by the association system, is only consisted of digit(s) and/or letter(s), which have not any special (especially, politic or geographic) meaning. This ensures that a person-oriented number can be used in any countries without troubles and that a subscriber's person-oriented number can be seen as his/her worldwide I.D., by which he/she is able to be reached by a person-oriented calling way even when he/she has relocated abroad.

In accordance with the seventh aspect of the present invention, all of the person-oriented numbers are designed from a single number pool having unlimited value of numbers though only the numbers having 10 digits are sufficient to satisfy the requirement for assigning the person-oriented numbers throughout the world.

### DETIALED DESCRIPTION OF THE INVENTION

The running Process of the Association System

1. Calling Process

To implement a calling process in the person-oriented way according to the present invention, there are 3 sides, which include a caller, the service management point (SMP) or other kind of service control point of a TTS, and a workstation of the association system doing their works respectively.

The caller dials the called person's person-oriented number (b) following the signal number (a) representing the calling way as the person-oriented calling way. And the process is proceeding inside the TTS locally. Notice that the connection between the caller's telephone set and the SMP will be kept continuously in the following step.

The service management point (SMP) will connect with a workstation of the association system after getting the signal number (a), and pass the number (b) to the workstation of the association system. The workstation, after getting the machine-oriented telephone number (c) relevant to the number (b), will return a number (c) to the SMP. Notice that the connection between the SMP and the workstation of the association system can be turned off after that number (c) has been returned successfully.

The SMP gets the called person's phone connected to the caller's phone by the number (c) in a usual way.

In the following explanation, we will call the above three steps as, respectively, dialing-up step, converting step and dialing-down step.

The converting step in the above process may be finished locally at the city, where the caller is located currently, if there is a workstation of the database system at the city. The situation is different from the UPT way, in which a converting step is always finished in a city where the subscriber's, i.e., called person's UPT provider is located, no matter whether or not the subscriber moves to some other cities.

2. Data Updating from a Subscriber

A subscriber may input a machine-oriented telephone number available for him (1) by making a call to any workstation of the database system, especially, the nearest-for-him workstation of the database system or (2) through Internet etc. Please note that since the database system is a telecommunication user but not a telecommunication provider, a subscriber's updating process happens directly between a subscriber and a workstation of the database system. And since the updating process happens directly between a subscriber and the nearest-for-him workstation of the database system, the updating process is a short-distance, even a local call having no relation with the telephone telecommunication provider located at the subscriber's original resident city.

Please note further that, since both the converting process and the subscriber's updating process can be finished (1) at any city where there is a workstation of the database, rather than the city where a subscriber got his person-oriented number, especially (2) at the place(s) where the caller and the subscriber are respectively located currently, a person's person-orientation number may, of course, be kept for all his/her lifetime.

3. Updating of the Database System

A subscriber maybe shall register his available machine-oriented telephone number to many but not merely one workstation of the database system because his friends may locate at many different cities in the world. This is why a workstation of the database system should pass its updated data to any other workstations of the database system, which need to store the updated data. The updating process for all of the workstations of the database system may run every minutes by batch processing way via web or Internet. The updating process makes sure that a person may be reach by his/her friends located in different position in the world by using his person-oriented number.

It is preferable for the association system of the present invention to make its workstations to be widely distributed. To make workstations of the database system widely distributed is very helpful to reduce the busy situation of converting step, when many callers located in many cities are respectively making their phone calls by the person-oriented calling way at the same time. On the other hand, it is easier to set up a workstation of a database system than to make telecommunication providers in different cities working coordinately for converting a person-oriented number with provider information (i.e. routing information) to a machine-oriented telephone number. And it is very easier to make the workstations belongs to the same database system run coordinately than to make many telecommunication providers located in different cities work coordinately.

4. Numbering Way of Person-Oriented Numbers

According to the present invention, it is preferable that the numbering way ignores telephone telecommunication routing information. This is different from a UPT number containing a sign of a telecommunication provider or a telephone geographic code. There has never existed a user's number without telephone telecommunication routing information, for example, the information about telephone telecommunication provider or telephone geographic code, since Bell invented telephone. Three points of the present invention support the numbering way ignoring any telephone telecommunication routing information. The three points makes a current TTS to route a caller's phone set to a called phone set in its usual way after finishing a calling-up step and a converting step. The three points are: (1) the database system has widely distributed workstations, which pass the updated data to each other; (2) the database system is an association system for a TTS but not a real telecommunication provider defined by a telephone geographic code etc. (3) the converting step from a person-oriented number to its relevant machine-oriented telephone number only temporarily exists in one of the three steps of a calling process.

On the other hand, only the idea ignoring telephone telecommunication routine information can make the relevant numbering way coordinating with human's activities. At first, the resource value of person-oriented number of the numbering way is unlimited since it is not a real phone number. This is another additional supporting point to ensure that every person in the world has his/her person-oriented number(s) owned uniquely by the person himself in his/her lifetime. Secondly, the format of a person-oriented number of the numbering way can be designed freely, for example, by using a positive integer having a longer or a shorter digit, or even by using the symbols including letter(s) etc. Thirdly, all of the person-oriented numbers of the subscribers throughout the world can be designed from a uniquely single pool. For example, a number pool, in which the longest number has 10 digits, is sufficient to satisfy the requirement of all the subscribers throughout the world. There are many numbering ways in UPT and the best way is structure scenario 3a, which only has limited number—1 milliard at most in its pool. At last, a person-oriented number under the numbering way is, in view of technique, able to be accepted to work coordinately by any kind of telecommunication companies—wire or wireless etc. since it is not a real phone number of any telephone telecommunication company.

5. About the Workstations of the Database System

About the Allocation of the Workstations of the Database System

It is preferable that there is a workstation of the database system almost in every regional unit for telephone telecommunication service. This is welcomed by two kinds of human beings: 1) who often make traveling; 2) whose callers locate at many different cities. Depending on the different demands of the customers, the practical workstations of the database system can be divided into different levels in order to execute their task in a cheaper way.

Functions of the Workstations of the Database System

A traveling subscriber can make a local phone call to change his/her machine-oriented telephone number in his/her traveled location, if there is a workstation of the database system in the traveled city. At the same time, the converting process from the traveler's person-oriented number into his/her current machine-oriented telephone number will be certainly very fast, if there is a workstation of the database system in the city where the traveler's caller is located.

By the widely spread workstations of the database system, the members of a family having moved and resided to an other city will not need to change their person-oriented numbers. The association system ensures them to keep the old relation with friends etc. while they do not need to inform their friends the matter of their moving or residing. And the above way is coordinate with human's behavior, because it makes a man to keep touch with his friends and relation in all of his lifetime, even in moving and after immigrating.

6. Functions of the Running Way of the Present Invention

The running way of the association system of the present invention based upon the database system with widely spreading workstation is able to support an international company being always in ready situation, to do all of the works for converting a person-oriented number to its relevant machine-oriented telephone number for a person-oriented calling process from any cities throughout the world. And, more interesting, there is usually only one workstation of the database system involved in a practical converting step process. On the contrary, the UPT running way to do the same works is based upon a cooperation of many UPT providers located in many cities in the world. The way of the present invention is cheaper and faster.

The association system of the present invention can support charging and billing ways, which may make telephone call charging based on a caller's person-oriented number become very simple. Charging and billing by a caller's person-oriented number are difficult things currently though they are very important both to a telephone company and a customer. By the running way of the association system of the present invention, there exists a potential way, by which it is able to gather all of the charge data and payment data on every subscriber from all of the workstations of the database system and to send a bill to every subscriber at the location the subscriber indicates. The only thing to do the works described in the above is that a current telephone telecommunication company transforms the related charging data on all of the active calls based upon every person-oriented number to a workstation of the database system periodically. The database system may be developed as a middle business organization, which charges from its subscribers and pays the expenses of its subscribers to every telephone telecommunication companies located in different geographic regions.

7. The Independently Running Way of the Database System

The database system on the relation between a person-oriented number and its relevant machine-oriented telephone number(s) is able to be designed as a system running outside any telephone calling process, when the database system is not able to work with a ITS for converting step. The examples are: (1) The database system can do its service under web or Internet; (2) The database system supports the services to a customer to look for a friend's machine-oriented telephone number by inputting the friend's person-oriented number and supports a subscriber to update his/her own machine-oriented telephone number by inputting his/her person-oriented number and own password, etc. via a call or web/Internet.

The invention has been described in details in the above, which however, is not used to limit the invention. And the invention may be modified and improved without departing the sprit and the scope of the claims.

What is claimed is:

1. A person-oriented running method for telephone calling process by dialing a person-oriented number without any telephone telecommunication routing information, in parallel with machine-oriented telephone calling process, wherein
1) the main part of all of the dialed digits in the person-oriented calling process being the person-oriented number without any telephone telecommunication routing information, which identifies a called person himself directly but not a telephone set serving to the called person;
2) a telephone telecommunication system (TTS) querying the database system in a workstation, especially, in the nearest workstation, recording the relation between a person-oriented number and its relevant machine-oriented telephone number(s), retrieving the machine-oriented telephone number(s) given by the called person, and then executing the calling process normally based upon one of the called person's machine-oriented telephone number(s), when the calling way is detected as a person-oriented calling way, will first.

2. An association system running independently outside a TTS but being able to run cooperatively with the TTS for telephone calling process, wherein
1) the association system being a database system storing the relation between a person-oriented number without any telephone telecommunication routing information and it's relevant machine-oriented telephone number(s);
2) the system being able to be connected to a TTS by a signal number identifying the person-oriented calling way;
3) when a caller makes a phone call by dialing the signal number followed by a called person's person-oriented number to a ITS, the association system being connected to the TTS, retrieving the relevant machine-oriented telephone number(s) based upon the person-oriented number passed by the ITS, and returning the machine-oriented telephone number(s) to the TTS which executes the calling process for connecting the called person's phone to the calling person's phone in a normal way, wherein the TTS is any of the followings: analog TTS, digital TTS, a wire TTS or a wireless TTS.

3. A numbering method for encoding a person-oriented number of a database system to assist a TTS in executing a person-oriented calling process, wherein the number being without any telephone telecommunication routing information and being a positive integer, having 10 or more digits, being encoded as the person-oriented number for a subscriber of the database system.

4. A numbering method for encoding person-oriented numbers of a database system to assist a ITS in executing a person-oriented calling process, wherein all of the person-oriented numbers for all of the subscribers of the database system throughout the world being fetched from the same number pool, each of said person-oriented numbers of each of said subscribers being owned uniquely by the subscriber himself throughout the world and having no telephone telecommunication routing information.

5. A database system for recording the relation between a person-oriented number and its relevant machine-oriented telephone number(s) and for aiding a TTS to execute a person-oriented calling process, wherein
1) a person-oriented number not containing any telephone telecommunication routing information being used to identify a subscriber;
2) the database system having many widely distributed workstations in order that a TTS queries the database system and converts a person-oriented number to its relevant machine-oriented telephone number(s) in a near location and even locally and a subscriber inputs or corrects his telephone number currently serving himself in a near location and even locally;
3) the database system having its workstations which transmit the changed and new data to each other, in order to keep the data in the database system reliable and in real-time;
4) any kind of telephone (company) telecommunication system, including analog, digital, wire, wireless system, being able to query its nearest or any other workstation of the database system and retrieve the relevant machine-oriented telephone number(s) by passing a person-oriented number to the workstation;
5) A subscriber sending his requirement about correcting his relevant current machine-oriented telephone number(s) serving him, to the nearest or any other workstation of the database system through a predefined way such as a phone call or Internet.

6. A service system in network, for providing retrieving service on the relation between a person-oriented number and its relevant machine-oriented number(s),
1) providing service to store and manage the data on the relation between a person-oriented number and its relevant machine-oriented telephone number(s), for receiving the machine-oriented number and the unique person-oriented number supplied by a user, keeping the person-oriented number being unique in the database;
2) assigning a person-oriented number to an applicant and keeping the person-oriented number owned uniquely by the applicant, assigning an other person-oriented number to an applicant who has already owned one or more person-oriented number(s), and keeping the new person-oriented number owned uniquely by the applicant;
3) supporting the service to check and retrieve the relevant machine-oriented telephone number(s) of a person-oriented number;
4) accepting the machine-oriented telephone number(s) input instruction from a subscriber at any time, and updating the related data in time; and
5) updating the machine-oriented telephone number(s) on a subscriber in responding to the subscriber's instruction.
